(19) United States
(12) Patent Application Publication
(10) Pub. No.: US 2006/0053051 A1
(43) Pub. Date: Mar. 9, 2006

(54) Genergraphic websites

(76) Inventor: Philip Goodman, Carlsbad, CA (US)

Correspondence Address: EVERITT BEERS, 5000 HOPYARD ROAD, SUITE 400, PLEASANTON, CA, 94588, US

(21) Appl. No.: 10/936,231

(22) Filed: Sep. 7, 2004

(51) Int. Cl. G06Q 30/00

(52) U.S. Cl. 705/14

(57) ABSTRACT

The present invention relates to providing of media descriptions of objects on the Internet by providing alternative descriptions of those objects based on the user's reaction to the descriptions. More particularly, the present invention relates to the creation and maintenance of data and presentations based on the generation-based mindsets of users or consumers and the use of those models to aid in presenting targeted content. An object of this invention is to formally apply psychographic and generational research to marketing plans to create successful advertising messages and promotions to specific generation-based mindsets.

### I. BACKGROUND OF THE INVENTION

A. Field of the Invention

The present invention relates to providing of media descriptions of objects on the Internet by providing alternative descriptions of those objects based on the user's reaction to the descriptions. More particularly, the present invention relates to the creation and maintenance of data and presentations based on the generation-based mindsets of users or consumers and the use of those models to aid in presenting targeted content, such as advertising or special offers.

B. Related Art

A key goal of most businesses is to target consumers with products and services that are of interest to the consumer based on their interests, preferences, or demographics. Thus many attempts have been made to determine consumer's interests and provide content (e.g. promotions, advertisements) to products and services that match such interests.

With the rise of consumer use of the Internet, advertisers have sought out ways to target information and advertising to consumers viewing web pages and the like. On the World Wide Web, “banner” advertising is typically used to promote products or services to consumers viewing various web pages. Many web sites attempt to target banner advertising based on the content of a user's input, typically a search request, or other consumer input that is processed by the web site.

As the user navigates through the presentation in one or more of its modes of operation, his selection process is monitored not only for his overt acts concerning selected goods and services, but also for factors revealed by the user's selection process. Among factors that are analyzed are the time the user spends with various aspects of the presentation; the manner the user prefers to interact with the media (i.e., by mouse, voice or keyboard); and the number of times the user returns to a particular subject. In this way, the system accumulates information about the user and his preference and modifies the presentation on the fly to accommodate them.

### II. OBJECTS AND ADVANTAGES OF THE INVENTION

The field and study of genergraphics is aimed at differentiating the attitudes, lifestyles, and buying patterns by generation. Using a unique method of psychographic differentiation based upon lifestyle questions, these studies have enabled major international companies to achieve major increases in brand awareness and sales. This field of study has shown that certain products and services appeal to all generations at different levels.

For 2004, the following are the ages for each generation:
Seniors: 69+ years old
The Forgotten Generation 59-68
Boomers: Older: 48-58
Boomers: Younger: 40-47
Generation X: 28-39
Echoboomers: older: 22-27
Echoboomers: medium: 16-21
Echoboomers: younger: 11-15

The “Generation Miner” is a proprietary system that encompasses the methodology, interpretation and applications to identify customers by psychographics (not just demographics), target content to get their attention, and position products, services and marketing communications to maximize sales and profits.

The Generation Miner is a suite of tools that join the power of psychographics and behavioral research to generational marketing. It takes into account differences in life experience that shape the values of each generation—differences which profoundly affect the ways that their members live and consume, and how they respond to advertising.

Those who are 50 and over are 3 distinct target markets. The smallest portion of the large 76 million boomers are 50-57 years old in 2003. The Forgotten Generation (58-67) is the “middle child” who straddles the “traditions of the past” of the seniors (68+).

This is particularly important for businesses. If you sell products and services to the current senior generations, who are 68+, their market is dying off. Businesses everywhere are beginning to scratch their heads trying to figure out why the Forgottens and Boomers are not interested in what the “seniors” bought before at the same age.

Demographics are not as important as strategies based on the psychology of individuals. Demographics tend to look at past patterns which miserably fail to predict what Boomers, their children and grandchildren will do and buy.

This psychological evaluation (or psychographics) is based upon observation and experience coupled with a system for quantifying and interpreting the attitude patterns observed. Research into this field of study has pointed to a generation of people who did not, and would not, follow in the footsteps of their parents. This generation, called Baby Boomers consists of the post World War II babies world wide born between the 19 years of 1946-1964. In the United States alone they account for over 76 million people.

An object of this invention is to formally apply psychographic and generational research to clients marketing plans to create highly successful advertising messages and promotions to the Boomers and the younger generations (Generation X and Echo Boomers) Boomers influence.

Generation based marketing allows businesses to:
1. Get closer to its customer by understanding their core values and needs.
2. Identify strong market segments within each generation based on differences in actual consumer behavior.
3. Reposition their products or services to meet the needs and expectations of new generations as they transition into their market's target age range.
4. Reach new age groups by appealing to their core values and needs.
5. Enhance cross-sell opportunities by knowing the entire market basket of goods and services used by different segments within each of the generations.
6. Determine future demand in a dynamic marketplace as different generations mature and younger generations enter their prime earning years.

### III. BRIEF DESCRIPTION OF DRAWINGS

FIG. 1 is a graphical depiction of the invention, showing the generational linking of web pages.

### IV. DESCRIPTION OF THE INVENTION

In accordance with the present invention, network presentations to be rendered at the user's terminal are programmed to exploit the advantages of rich media to expand user's ability to effectively receive information about selection preferences sent back over the network to the transmitting website as the presentation proceeds. In response to interrogation by a user for goods of services, the system presents a hypermedia presentation that starts out with delivery and presentation of simple thumbnail descriptions of the available goods and services, and proceeds in steps through delivery and presentation of more complex descriptions.

The presentations are arranged in segments and permit multiple modes of operation. Each mode has a different set of attributes that permit progress through the presentation in a different manner. When a user first enters a website, he is placed in navigation mode that enables him to browse the website by moving from category to category of goods, having an initial look at the offerings of each category. The user can then move on to the inspection and/or transaction modes.

In the inspection mode, the user can examine in more detail the various aspects of the goods he is interested in, changing to a more detailed explanation to zoom in on various portions of the goods and obtain related information. When the user enters the transaction mode, he is apparently ready to purchase the goods and is given appropriate options for this purpose, such as obtaining a quote, asking for human assistance, and triggering a transaction.

On each of the initial inspection mode pages, the user is presented with a page containing multiple links. Each link is presented with media and characterizations based on the generational mindset of different generations. Each generational link is then connected to additional pages that further present information on the product based on the generational mindset of the user.

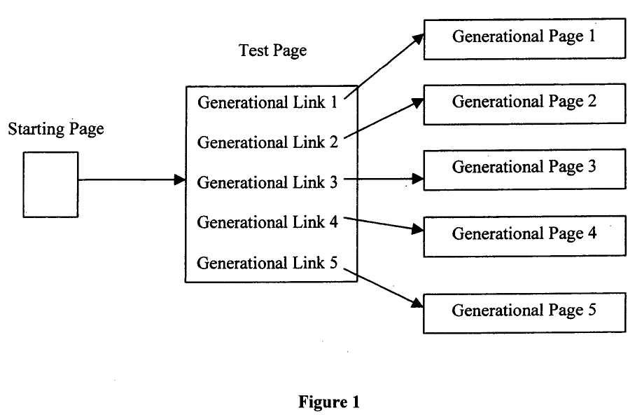

FIG. 1 shows a graphical representation of the present invention. As depicted in FIG. 1, a user is first confronted with a Starting Page. The Starting Page is a generic introduction to the website, containing such general information as basic vendor and product identification. After first seeing the Starting Page, the use is then presented with the Test Page. The Test Page contains multiple links. In FIG. 1, these multiple links are listed as Generational Links. Each of these Generational Links is accompanied by images and text, possibly in thumbnail fashion, tailored to the likes of a particular Generational Mindset. In turn, each of the Generational Links leads to one or more web pages particularly designed to appeal to a particular Generational Mindset. These pages are labeled in FIG. 1 as Generational Pages. Each of the Generational Pages can conceptually have any number of later pages linked to it, also based on the Generational Mindset of the initial Generational Link.

FIG. 1 depicts but one implementation of the Genergraphics. Although this description contains many specificities, these should not be construed as limiting the scope of the present invention, but as merely providing illustrations of some of the presently preferred embodiments of aspects of the invention. Thus, the scope of the invention should be determined by the appended claims and their legal equivalents, rather than by the examples given.

What is claimed is:

1. A method for providing personalized media presentations over a network to a user's terminal comprising:
a) delivering to the terminal presentation streams containing links characterized and labeled by presentations developed based on the generational mindset of the user;
b) providing at least one page of media presentation navigated to through each link that is tailored to the needs and desires of a particular generational mindset.

2. The method of claim 1 wherein six different modes of operation in a presentation includes;
a) a first navigation mode providing means to navigate a website that caters to the genergraphics of the Senior generation;
b) a second navigation mode providing means to navigate a website that caters to the genergraphics of the Forgotten generation;
c) a third navigation mode providing means to navigate a website that caters to the genergraphics of the Boomer generation;
d) a fourth navigation mode providing means to navigate a website that caters to the genergraphics of the X generation;
e) a fifth navigation mode providing means to navigate a website that caters to the genergraphics of the Echo Boomer generation;
f) a sixth navigation mode providing means to navigate a website that caters to the genergraphics of the Millennium generation;

3. The website of claim 2, including first delivering to the terminal a hypermedia presentation stream at a level of the hierarchy with more abstract attributes of an item and thereafter delivering to the terminal at that level of the hierarchy in order of increasing refinement only those of the attributes in the hypermedia stream that reflect the user's generational mind set as expressed by navigation events.
